(19) United States
(12) Patent Application Publication
(10) Pub. No.: US 2019/0379509 A1
(43) Pub. Date: Dec. 12, 2019

(54) User Equipment-Initiated Phase Tracking for Fifth Generation New Radio

(71) Applicant: Google LLC, Mountain View, CA (US)

(72) Inventors: Erik Richard Stauffer, Sunnyvale, CA (US); Jibing Wang, Saratoga, CA (US)

(73) Assignee: Google LLC, Mountain View, CA (US)

(21) Appl. No.: 16/003,826

(22) Filed: Jun. 8, 2018

(51) Int. Cl. H04L 5/00

(52) U.S. Cl. CPC H04L 5/0053; H04W 84/042

(57) ABSTRACT

In aspects of user equipment-initiated phase tracking for fifth generation new radio, a method, device, and system are described for configuring phase-tracking reference signals by a user device in a wireless communication network. The user device determines a current operating condition for a wireless communication link and based on the current operating condition, selects a configuration for one or more air interface resources, each air interface resource being selected to transmit a phase-tracking reference signal. The user device transmits a request that includes the selected configuration to a base station and receives, from the base station, the one or more air interface resources that each includes a phase-tracking reference signal.

### BACKGROUND

The evolution of wireless communication to fifth generation (5G) standards and technologies provides higher data rates and greater capacity, with improved reliability and lower latency, which enhances mobile broadband services. 5G technologies also provide new classes of services for vehicular networking, fixed wireless broadband, and the Internet of Things (IoT).

A unified air interface, which utilizes licensed, unlicensed, and shared license radio spectrum in multiple frequency bands is one aspect of enabling the capabilities of 5G systems. The 5G air interface utilizes radio spectrum in bands below 1 GHz (sub-gigahertz), below 6 GHz (sub-6 GHz), and above 6 GHz. Radio spectrum above 6 GHz includes millimeter wave (mmWave) frequency bands that provide wide channel bandwidths to support higher data rates for wireless broadband.

While operation at higher frequencies, such as mmWave frequencies, supports higher data rates, there are challenges to operation at higher frequencies. As operational frequencies increase, the phase noise output of oscillators increases as well, which can degrade the performance of Orthogonal Frequency Divisional Multiplexing (OFDM) receivers. The specification of the features in the 5G air interface is defined as 5G New Radio (5G NR). To compensate for performance degradations, the standards for 5G NR define a Phase-Tracking Reference Signal (PT-RS) that is transmitted in downlink and uplink radio signals to assist receivers in mitigating the effects of phase noise on receiver performance. The base station determines whether the PT-RS is transmitted, and the resources used for the transmission of the PT-RS.

The reference oscillator in each user equipment (UE) may have different phase noise characteristics, as well as operating in environments with differing amounts and types of environmental noise and interference. The base station possesses neither knowledge of the phase noise characteristics of each UE, nor knowledge of the environmental noise and interference experienced by each UE. When the base station transmits the PT-RS unnecessarily, network resources are used inefficiently, reducing the availability of resources for transmitting or receiving user application data. When the base station decides not to transmit the PT-RS or transmits the PT-RS using a suboptimal set of resources than those that would improve reception for a UE, receiver error rates increase, which can lead to lost data, retransmissions, increased latency, and lower network efficiency. By being dependent on the base station to determine when to transmit the PT-RS and which resources to use for the transmission of the PT-RS, the user equipment is limited in compensating for internally-generated and externally-imposed noise to improve receiver performance.

### SUMMARY

This summary is provided to introduce simplified concepts of user equipment-initiated phase tracking for fifth generation new radio. The simplified concepts are further described below in the Detailed Description. This summary is not intended to identify essential features of the claimed subject matter, nor is it intended for use in determining the scope of the claimed subject matter.

In some aspects, a method for configuring phase-tracking reference signals by a user device in a wireless communication network is described, in which the user device determines a current operating condition for a wireless communication link, and based on the current operating condition, selects a configuration for one or more air interface resources, with each air interface resource being selected to transmit a phase-tracking reference signal. The user device transmits a request that includes the selected configuration for the one or more air interface resources to a base station and receives, from the base station, the one or more air interface resources that each include the phase-tracking reference signal.

In other aspects, a mobile communication device includes a radio frequency (RF) transceiver and a processor and memory system to implement a phase tracking manager application that determines a current operating condition of a wireless communication link between the mobile communication device and a base station. Based on the current operating condition, the mobile communication device selects a configuration for one or more air interface resources, with each air interface resource being selected to transmit a phase-tracking pilot signal, transmits a request that includes the selected configuration for the one or more air interface resources to the base station using the RF transceiver, and receives, using the RF transceiver, the one or more air interface resources that each includes the phase-tracking reference signal.

In further aspects, a system includes a gNode B (gNB) and a user equipment (UE). The UE is configured to determine a current operating condition of a wireless communication link between the UE and the gNB, and based on the current operating condition, select a configuration for one or more resource elements, with each resource element being selected to transmit a phase-tracking pilot signal. The UE is configured to transmit a request to the gNB, the request including the selected configuration for the one or more resource elements, and receive from the gNB the one or more resource elements that each includes the phase-tracking reference signal.

### BRIEF DESCRIPTION OF THE DRAWINGS

Aspects of user equipment-initiated phase tracking for fifth generation new radio are described with reference to the following drawings. The same numbers are used throughout the drawings to reference like features and components:

FIG. 1 illustrates an example wireless network environment in which various aspects of user equipment-initiated phase tracking for fifth generation new radio can be implemented.

FIG. 2 illustrates an example device diagram that can implement various aspects of user equipment-initiated phase tracking for fifth generation new radio.

FIG. 3 illustrates an air interface resource that extends between a user equipment and a base station and with which various aspects of user equipment-initiated phase tracking for fifth generation new radio techniques can be implemented.

FIG. 4a illustrates an example of a phase-tracking reference signal density in the frequency domain in accordance with aspects of user equipment-initiated phase tracking for fifth generation new radio techniques.

FIG. 4b illustrates an example of a phase-tracking reference signal density in the time domain in accordance with aspects of user equipment-initiated phase tracking for fifth generation new radio techniques.

FIG. 4c illustrates an example of a phase-tracking reference signal density in the frequency and time domains in accordance with aspects of user equipment-initiated phase tracking for fifth generation new radio techniques.

FIG. 5 illustrates an example method of user equipment-initiated phase tracking for fifth generation new radio as generally related to determining a configuration of, and transmitting request for, phase-tracking reference signals by the user equipment in accordance with aspects of the techniques described herein.

FIG. 6 illustrates an example method of user equipment-initiated phase tracking for fifth generation new radio as generally related to reception, by a base station, of a request to configure and transmit phase-tracking reference signals by the base station in accordance with aspects of the techniques described herein.

FIG. 7 illustrates an example communication device that can be implemented in a wireless network environment in accordance with one or more aspects of the techniques described herein.

### DETAILED DESCRIPTION

### Overview

This document describes techniques using, and devices enabling a user device to configure and control transmission of phase-tracking reference signals based on characteristics of the user device and its environment. For example, a user device can evaluate an operating condition, such as a phase noise characteristic of the user device, a noise floor of the user device, a temperature of the user device, a carrier frequency, a frequency band, or any combination thereof, to determine how to configure air interface resources to transmit phase-tracking reference signals between the user device and a base station. The user device can transmit a request to the base station to configure, turn on, or turn off the transmission of the phase-tracking reference signals that enable the user device to improve reception by compensating for noise in received wireless signals using the phase-tracking reference signals.

As wireless communication systems evolve to 5G NR technologies, 5G networks will be deployed using new radio spectrum at higher radio frequencies that provide wide channel bandwidths to support higher data rates for wireless broadband. As operational frequencies increase, the phase noise output of oscillators increases as well, which can degrade the performance of Orthogonal Frequency Divisional Multiplexing (OFDM) receivers. Increasing levels of phase noise in received signals can cause inter-carrier interference between subcarriers of an OFDM signal, and increased phase noise in the oscillator of a receiver can increase the level of the noise floor of the receiver, reducing the sensitivity of the receiver.

To compensate for performance degradations from increased noise, the standards for 5G NR define a Phase-Tracking Reference Signal (PT-RS) that is transmitted in downlink and uplink radio signals to assist receivers in mitigating the effects of phase noise on receiver performance. The PT-RS can be used by a receiver to correct for Common Phase Error (CPE) that is a phase rotation that is common to all OFDM subcarriers or to correct for various forms of additive noise, such as noise that causes Inter-Carrier Interference (ICI) between the OFDM subcarriers.

Whether the PT-RS is to be transmitted and the resources used for the transmission of the PT-RS are determined by the base station. The determination by the base station of when and how to transmit the PT-RS by the base station does not consider the characteristics and environment of each user equipment served by the base station. If the transmission schedule and resources chosen by the base station for the PT-RS are inadequate for the user equipment to track the phase trajectory of a received signal, the user equipment may not adequately compensate for noise, resulting in increased error rates and less efficient utilization of network resources.

In aspects of user equipment-initiated phase tracking for fifth generation new radio, a method, device, and system are described for configuring phase-tracking reference signals by a user device in a wireless communication network. The user device determines a current operating condition for a wireless communication link and based on the current operating condition, selects a configuration for one or more air interface resources, each air interface resource being selected to transmit a phase-tracking reference signal. The user device transmits a request that includes the selected configuration to a base station and receives, from the base station, the one or more air interface resources that each includes a phase-tracking reference signal.

User equipment-initiated phase tracking for fifth generation new radio provides the UE with the capability to dynamically request that the transmission of the PT-RS be turned on or off, as well as enabling the user equipment to request specific phase-tracking reference signal densities, including density in the frequency domain, density in the time domain, or both. The user equipment can configure the PT-RS based on the characteristics of the user equipment, localized conditions of the radio environment about the user equipment, or both. By controlling the PT-RS, the user equipment can better compensate for increased noise conditions to reduce reception error rates and increase the efficiency of utilization of wireless network resources. When environmental noise is low, internally-generated noise is not a factor, or both, the user equipment can turn off transmission of the PT-RS or reduce the density of PT-RS signals to increase network efficiency, increase battery life of the UE, or both.

The user equipment may have knowledge of the noise generated by circuitry in the user equipment. The user equipment may have been calibrated, either during manufacturing, during a self-calibration, or a combination of both, for noise at operating frequencies, for frequency bands, for various operational modes of the user equipment, and so forth. Calibration values for these noise characteristics are stored in the user equipment. The user equipment can determine, based on these stored calibration values and current operating conditions, if the PT-RS should be turned on for better receiver performance or if the PT-RS can be turned off without a negative effect on the performance of the wireless communication link between the user equipment and the base station, and increase battery life by not transmitting the PT-RS on the uplink.

In addition to knowledge of internal noise characteristics, the user equipment can determine if current noise conditions in the local radio environment of the user equipment are affecting receiver performance. The user equipment may monitor these external noise conditions directly by measuring noise, receiver performance, or both, at the physical level of the network stack in the user equipment. The user equipment may also monitor these external noise conditions indirectly by evaluating performance, errors, status information, or a combination of these, at upper layers of the network stack in the user equipment. For example, the user equipment may consider TCP retransmission requests, rejected packet rates at the Media Access Control (MAC) layer of the of the network stack, and the like, to infer that the receiver is being affected by noise.

While features and concepts of the described systems and methods for user equipment-initiated phase tracking for fifth generation new radio can be implemented in any number of different environments, systems, devices, and/or various configurations, aspects of user equipment-initiated phase tracking for fifth generation new radio are described in the context of the following example devices, systems, and configurations.

Example Environment

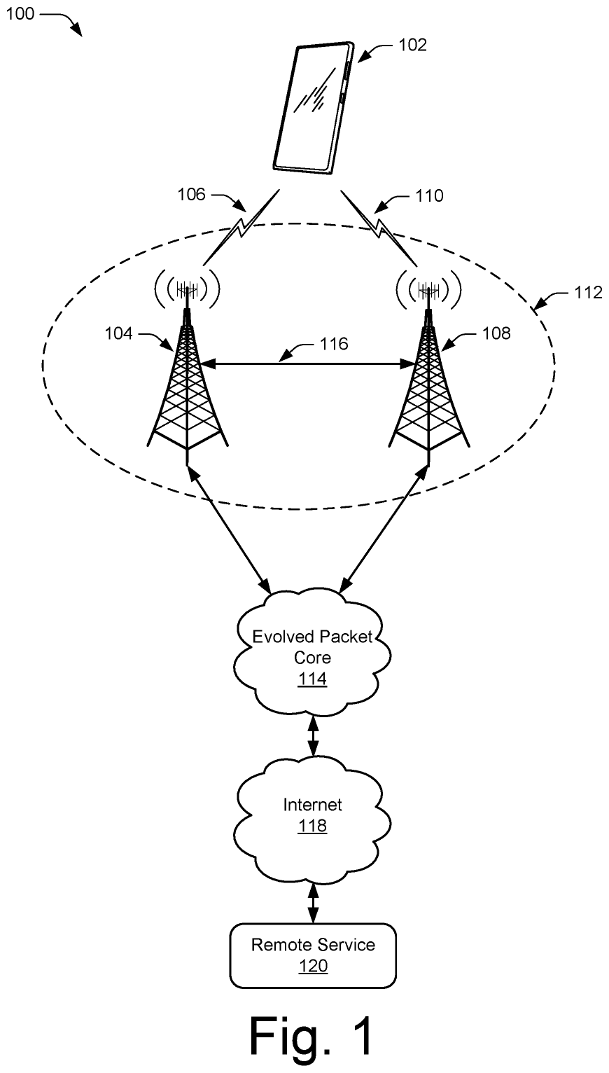

FIG. 1 illustrates an example environment 100 which includes a user equipment 102 (user device) that communicates with a base station 104 that acts as a serving cell, (serving cell base station 104), through a wireless communication link 106 (wireless link 106). In this example, the user equipment 102 is implemented as a smartphone. Although illustrated as a smartphone, the user equipment 102 may be implemented as any suitable computing or electronic device, such as a mobile communication device, a modem, cellular phone, gaming device, navigation device, media device, laptop computer, desktop computer, tablet computer, smart appliance, vehicle-based communication system, and the like. The base station 104 (e.g., an Evolved Universal Terrestrial Radio Access Network Node B, E-UTRAN Node B, evolved Node B, eNodeB, eNB, Next Generation Node B, gNode B, gNB, and the like) may be implemented in a macrocell, microcell, small cell, picocell, and the like, or any combination thereof.

The base station 104 communicates with the user equipment 102 via the wireless link 106, which may be implemented as any suitable type of wireless link. The wireless link 106 can include a downlink of data and control information communicated from the base station 104 to the user equipment 102, an uplink of other data and control information communicated from the user equipment 102 to the base station 104, or both. The wireless link 106 may include one or more wireless links or bearers implemented using any suitable communication protocol or standard, or combination of communication protocols or standards such as 3rd Generation Partnership Project Long-Term Evolution (3GPP LTE), 5G NR, and so forth.

In aspects, the user equipment 102 communicates with another base station 104 (a neighbor base station 108), via a wireless link 110. The wireless link 110 may be implemented using the same communication protocol or standard, or a different communication protocol or standard, than the wireless link 106. For example, the wireless link 106 is a 5G NR link and the wireless link 110 is an LTE link. The base station 104, the neighbor base station 108, and any additional base stations (not illustrated for clarity) are collectively a Radio Access Network 112 (RAN 112, Evolved Universal Terrestrial Radio Access Network 112, E-UTRAN 112), which are connected via an Evolved Packet Core 114 (EPC 114) network to form a wireless operator network. The base station 104 and the neighbor base station 108 can communicate using an Xn Application Protocol (XnAP), at 116, to exchange user-plane and control-plane data. The user equipment 102 may connect, via the EPC 114, to public networks, such as the Internet 118 to interact with a remote service 120.

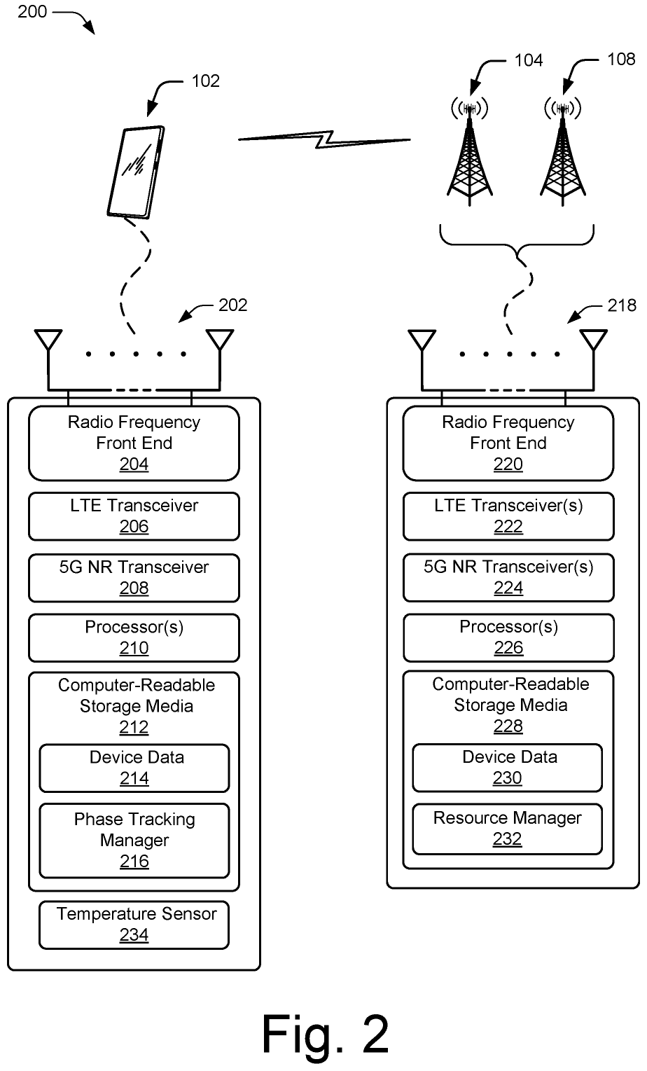

FIG. 2 illustrates an example device diagram 200 of the user equipment 102, the base station 104, and the neighbor base station 108. It should be noted that only the essential features of the user equipment 102, the base station 104, and the neighbor base station 108 are illustrated here for the sake of clarity. The user equipment 102 includes antennas 202, a radio frequency front end 204 (RF front end 204), an LTE transceiver 206, and a 5G NR transceiver 208 for communicating with base stations 104 in the E-UTRAN 112. The RF front end 204 of the user equipment 102 can couple or connect the LTE transceiver 206, and the 5G NR transceiver 208 to the antennas 202 to facilitate various types of wireless communication. The antennas 202 of the user equipment 102 may include an array of multiple antennas that are configured similar to or differently from each other. The antennas 202 and the RF front end 204 can be tuned to, and/or be tunable to, one or more frequency bands defined by the 3GPP LTE and 5G NR communication standards and implemented by the LTE transceiver 206, and/or the 5G NR transceiver 208. Additionally, the antennas 202, the RF front end 204, the LTE transceiver 206, and/or the 5G NR transceiver 208 may be configured to support beamforming for the transmission and reception of communications with the base station 104, the neighbor base station 108, or both. By way of example and not limitation, the antennas 202 and the RF front end 204 can be implemented for operation in sub-gigahertz bands, sub-6 GHZ bands, and/or above 6 GHz bands that are defined by the 3GPP LTE and 5G NR communication standards.

The user equipment 102 also includes processor(s) 210 and computer-readable storage media 212 (CRM 212). The processor 210 may be a single core processor or a multiple core processor composed of a variety of materials, such as silicon, polysilicon, high-K dielectric, copper, and so on. The computer-readable storage media described herein excludes propagating signals. CRM 212 may include any suitable memory or storage device such as random-access memory (RAM), static RAM (SRAM), dynamic RAM (DRAM), non-volatile RAM (NVRAM), read-only memory (ROM), or Flash memory useable to store device data 214 of the user equipment 102. The device data 214 includes user data, multimedia data, applications, and/or an operating system of the user equipment 102, which are executable by processor(s) 210 to enable user interaction with the user equipment 102.

CRM 212 also includes a phase tracking manager 216, which, in one implementation, is embodied on CRM 212 (as shown). Alternately or additionally, the phase tracking manager 216 may be implemented in whole or part as hardware logic or circuitry integrated with or separate from other components of the user equipment 102. In at least some aspects, the phase tracking manager 216 configures the RF front end 204, the LTE transceiver 206, and/or the 5G NR transceiver 208 to implement the techniques for user equipment-initiated phase tracking for fifth generation new radio described herein.

The device diagram for the base station 104 and the neighbor base station 108, shown in FIG. 2, includes a single network node (e.g., a gNode B). The functionality of the base station 104 or the neighbor base station 108 may be distributed across multiple network nodes or devices and may be distributed in any fashion suitable to perform the functions described herein. The base station 104 and the neighbor base station 108 include antennas 218, a radio frequency front end 220 (RF front end 220), one or more LTE transceivers 222, and/or one or more 5G NR transceivers 224 for communicating with the user equipment 102. The RF front end 220 of the base station 104 and the neighbor base station 108 can couple or connect the LTE transceivers 222 and the 5G NR transceivers 224 to the antennas 218 to facilitate various types of wireless communication. The antennas 218 of the base station 104 and the neighbor base station 108 may include an array of multiple antennas that are configured similar to or differently from each other. The antennas 218 and the RF front end 220 can be tuned to, and/or be tunable to, one or more frequency band defined by the 3GPP LTE and 5G NR communication standards, and implemented by the LTE transceivers 222, and/or the 5G NR transceivers 224. Additionally, the antennas 218, the RF front end 220, the LTE transceivers 222, and/or the 5G NR transceivers 224 may be configured to support beamforming, such as Massive-MIMO, for the transmission and reception of communications with the user equipment 102.

The base station 104 and the neighbor base station 108 also include processor(s) 226 and computer-readable storage media 228 (CRM 228). The processor 226 may be a single core processor or a multiple core processor composed of a variety of materials, such as silicon, polysilicon, high-K dielectric, copper, and so on. CRM 228 may include any suitable memory or storage device such as random-access memory (RAM), static RAM (SRAM), dynamic RAM (DRAM), non-volatile RAM (NVRAM), read-only memory (ROM), or Flash memory useable to store device data 230 of the base station 104 and the neighbor base station 108. The device data 230 includes network scheduling data, radio resource management data, applications, and/or an operating system of the base station 104 and the neighbor base station 108, which are executable by processor(s) 226 to enable communication with the user equipment 102.

CRM 228 also includes a resource manager 232, which, in one implementation, is embodied on CRM 228 (as shown). Alternately or additionally, the resource manager 232 may be implemented in whole or part as hardware logic or circuitry integrated with or separate from other components of the base station 104 and the neighbor base station 108. In at least some aspects, the resource manager 232 configures the LTE transceivers 222 and the 5G NR transceivers 224 for communication with the user equipment 102.

### User Equipment-Initiated Phase Tracking

In aspects, the user equipment 102 provides a request to the base station 104 to configure transmission of one or more Phase-Tracking Reference Signals (PT-RS) between the user equipment 102 and the base station 104. The configuration of the PT-RS includes requesting that the transmission of the PT-RS be turned on or off, as well as enabling the user equipment 102 to request specific phase tracking pilot signal densities, including density in the frequency domain, density in the time domain, or both. The PT-RS request to the base station 104 can be transmitted directly to the base station 104 or via a supplemental uplink, such as a supplemental uplink of the neighbor base station 108. The PT-RS request is transmitted using any suitable control communication, such as via a Radio Resource Control (RRC) connection, a Media Access Control (MAC) layer Information Element (IE), or a Physical Uplink Control Channel (PUCCH).

In determining to change the configuration of the PT-RS, the phase tracking manager 216 in the user equipment 102 considers the operational state of the user equipment 102, the performance of the wireless communication link 106, or both. To make a determination, the phase tracking manager 216 may consider any combination of: phase noise characteristics of the user equipment 102 that are stored in the device data 214 from factory calibrations or self-calibrations, an operating temperature of the user equipment 102 measured by a temperature sensor 234, radio measurements from the 5G NR transceiver 208, or operational information from various layers of the network stack in the user equipment 102, such as performance statistics, errors, and status information. The phase tracking manager 216 may configure resource elements for phase-tracking reference signals on a per-carrier basis, a per-frequency band, or based on channel spacings and channel bandwidths in use for the wireless communication link 106.

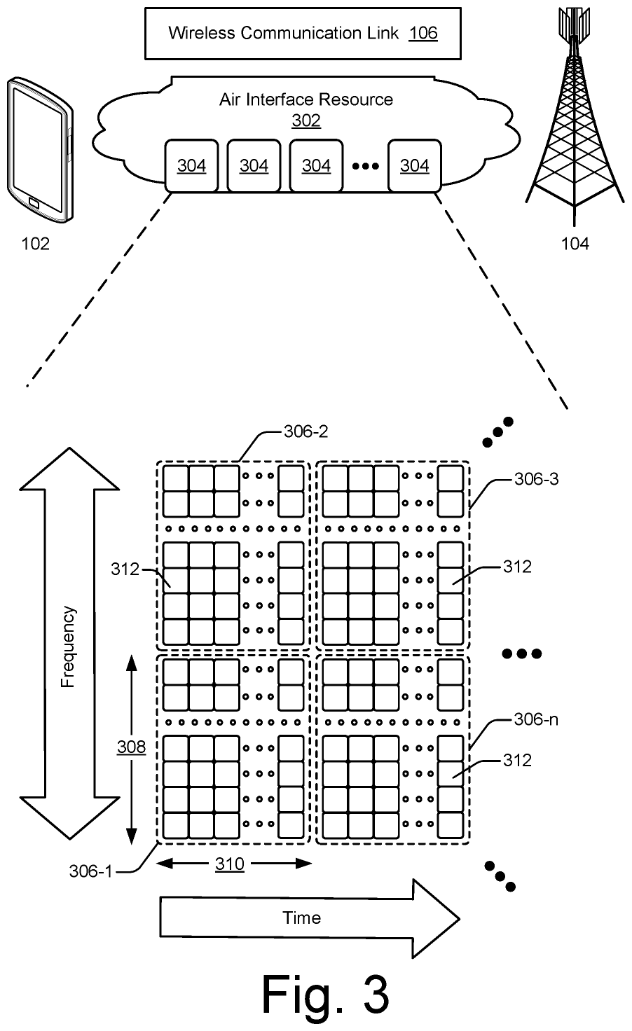

FIG. 3 illustrates an air interface resource that extends between a user equipment and a base station and with which various aspects of user equipment-initiated phase tracking for fifth generation new radio techniques can be implemented. The air interface resource 302 can be divided into resource units 304, each of which occupies some intersection of frequency spectrum and elapsed time. A portion of the air interface resource 302 is illustrated graphically in a grid or matrix having multiple resource blocks 306, including resource blocks 306-1, 306-2, 306-3 . . . 306-n, with “n” representing some positive integer. An example of a resource unit 304 therefore includes at least one resource block 306. As shown, time is depicted along the horizontal dimension as the abscissa axis, and frequency is depicted along the vertical dimension as the ordinate axis. The air interface resource 302, as defined by a given communication protocol or standard, may span any suitable specified frequency range and/or may be divided into intervals of any specified duration. Increments of time can correspond to, for example, milliseconds (mSec). Increments of frequency can correspond to, for example, megahertz (MHz).

In example operations generally, the base station 104 allocates portions (e.g., resource units 304) of the air interface resource 302 for uplink and downlink communications. Each resource block 306 of network access resources may be allocated to support respective wireless communication link 106 of multiple user equipment 102. In the lower left corner of the grid, the resource block 306-1 may span, as defined by a given communication protocol, a specified frequency range 308 and comprise multiple subcarriers or frequency sub-bands. The resource block 306-1 may include any suitable number of subcarriers (e.g., 12) that each correspond to a respective portion (e.g., 15 kHz) of the specified frequency range 308 (e.g., 180 kHz). The resource block 306-1 may also span, as defined by the given communication protocol, a specified time interval 310 or time slot (e.g., lasting approximately one-half millisecond or 7 orthogonal frequency-division multiplexing (OFDM) symbols). The time interval 310 includes subintervals that may each correspond to a symbol, such as an OFDM symbol. As shown in FIG. 3, each resource block 306 may include multiple resource elements 312 (REs) that correspond to, or are defined by, a subcarrier of the frequency range 308 and a subinterval (or symbol) of the time interval 310. Alternatively, a given resource element 312 may span more than one frequency subcarrier or symbol. Thus, a resource unit 304 may include at least one resource block 306, at least one resource element 312, and so forth.

In example implementations, multiple user equipment 102 (one of which is shown) are communicating with the base station 104 through access provided by portions of the air interface resource 302. The resource manager 232 (not shown in FIG. 3) may determine a respective type or amount of information (e.g., data or control information) to be communicated (e.g., transmitted) by the user equipment 102. For example, the resource manager 232 can determine that each user equipment 102 is to transmit a different respective amount of information. The resource manager 232 then allocates one or more resource blocks 306 to each user equipment 102 based on the determined amount of information.

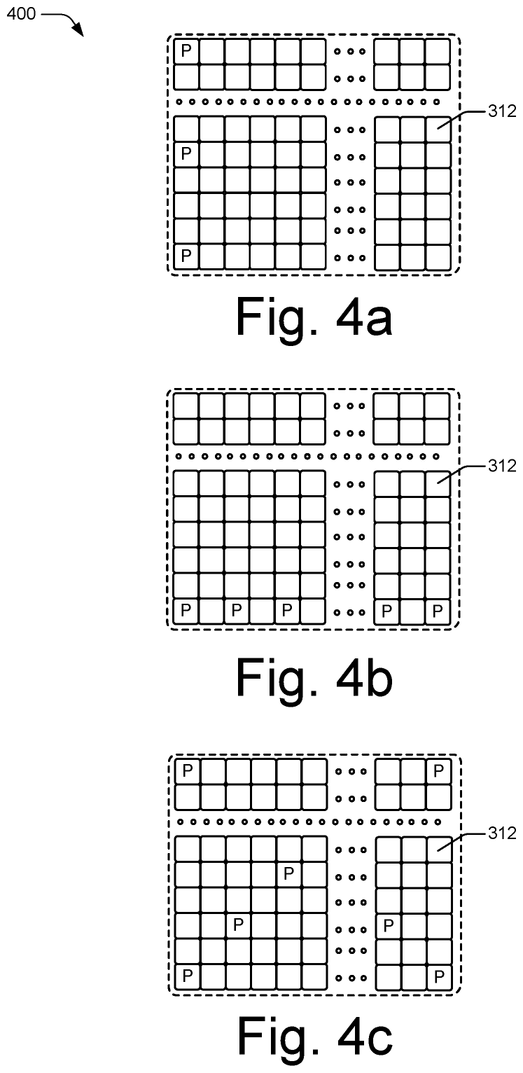

Additionally or in the alternative to block-level resource grants, the resource manager 232 may allocate resource units at an element-level. Thus, the resource manager 232 may allocate one or more resource elements 312 or individual subcarriers to different user equipment 102. By so doing, one resource block 306 can be allocated to facilitate network access for multiple user equipment 102. Accordingly, the resource manager 232 may allocate, at various granularities, one or up to all subcarriers or resource elements 312 of a resource block 306 to one user equipment 102 or divided across multiple user equipment 102, thereby enabling higher network utilization or increased spectrum efficiency. The air interface resource 302 can also be used to exchange PT-RS communications, which are described below starting at FIG. 4.

The resource manager 232 can therefore allocate air interface resource 302 by resource unit 304, resource block 306, frequency carrier, time interval, resource element 312, frequency subcarrier, time subinterval, symbol, spreading code, some combination thereof, and so forth. Based on respective allocations of resource units 304, the resource manager can transmit respective messages to the multiple user equipment 102 indicating the respective allocation of resource units 304 to each user equipment 102. Each message may enable a respective user equipment 102 to queue the information or configure the LTE transceiver 206, the 5G NR transceiver 208, or both to communicate via the allocated resource units 304 of the air interface resource 302.

By way of example, and not limitation, FIG. 4 illustrates examples of a phase-tracking reference signal density in the frequency domain, time domain, or both in accordance with aspects of user equipment-initiated phase tracking for fifth generation new radio techniques. The phase tracking manager 216 determines a configuration of the resource elements 312 to be used to transmit phase-tracking reference signals, based on the noise characteristics of the user equipment 102, current channel conditions for the wireless communication link 106, or both. The phase tracking manager 216 may configure any number of the resource elements 312, in any configuration within any resource unit 304, to transmit PT-RS signals in the frequency domain, the time domain, or both. The phase tracking manager 216 may configure the resource elements 312 to transmit PT-RS signals identically or differently for the uplink and the downlink of the wireless communication link 106. The configuration of PT-RS resource elements may be based on the carrier frequency or the frequency band of operation of the user equipment 102.

FIG. 4a illustrates an example of multiple resource elements 312 assigned for PT-RS transmissions in the frequency domain, as illustrated by a “P” in the respective resource elements 312. FIG. 4b illustrates an example of multiple resource elements 312 assigned for PT-RS transmissions in the time domain, as illustrated by a “P” in the respective resource elements 312. FIG. 4c illustrates an example of multiple resource elements 312 assigned for PT-RS transmissions in the frequency and time domains, as illustrated by a “P” in the respective resource elements 312.

Example Methods

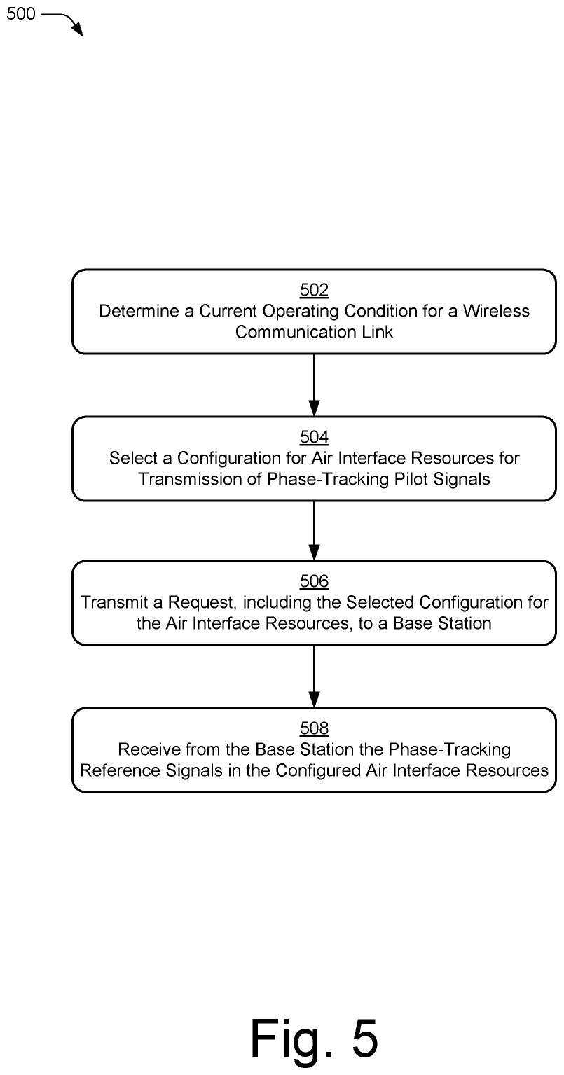

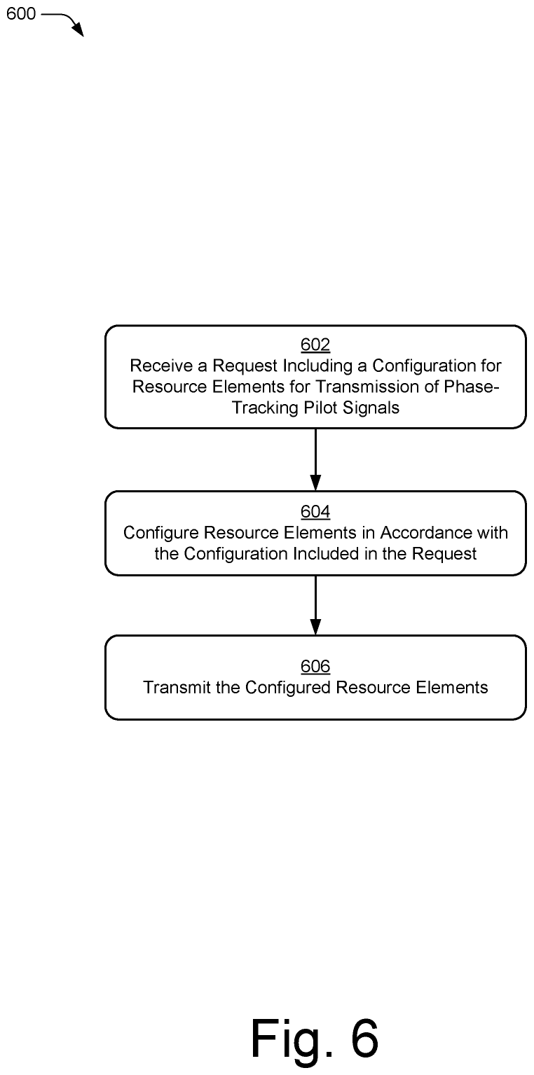

Example methods 500 and 600 are described with reference to FIGS. 5 and 6 in accordance with one or more aspects of user equipment-initiated phase tracking for fifth generation new radio. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 5 illustrates example method(s) 500 of user equipment-initiated phase tracking for fifth generation new radio as generally related to determining a configuration of, and transmitting request for, phase-tracking reference signals by the user equipment 102. The order in which the method blocks are described are not intended to be construed as a limitation, and any number of the described method blocks can be combined in any order to implement a method or an alternate method.

At block 502, a user device determines a current operating condition for a wireless communication link between the user device and a base station. For example, the user equipment 102 determines the current operating condition for the wireless communication link 106 based on a phase noise characteristic of the user equipment 102, a noise floor of the user equipment 102, a temperature of the user equipment 102, a carrier frequency, a frequency band, or any combination thereof.

At block 504, based on the determination of the current operating condition, the user device selects a configuration for one or more air interface resources, to transmit phase-tracking pilot signals. For example, the user equipment 102 selects a configuration of one or more resource elements 312 in the frequency domain, the time domain, or both, each resource element 312 being selected to transmit a phase-tracking pilot signal (PT-RS).

At block 506, the user device transmits a request that includes the selected configuration for one or more air interface resources to the base station. For example, the user equipment 102 transmits a request, including the selected configuration of the resource elements 312, to the base station 104 via a Radio Resource Control (RRC) connection, a Media Access Control (MAC) layer Information Element (IE), or a Physical Uplink Control Channel (PUCCH).

At block 508, the user device receives the phase-tracking pilot signals in the one or more configured air interface resources transmitted from the base station. For example, the user equipment 102 receives the phase-tracking pilot signals in the selected resource elements 312, in a transmission from the base station 104.

FIG. 6 illustrates example method(s) 600 of user equipment-initiated phase tracking for fifth generation new radio as generally related to reception, by a base station, of a request to configure and transmit phase-tracking reference signals by the base station. The order in which the method blocks are described are not intended to be construed as a limitation, and any number of the described method blocks can be combined in any order to implement a method, or an alternate method.

At block 602, the base station receives a request including a configuration for resource elements for transmission of phase-tracking reference signals. For example, the base station 104 receives a request including a configuration for the resource elements 312 to be used to transmit phase-tracking reference signals. The base station 104 receives the request via a Radio Resource Control (RRC) connection, a Media Access Control (MAC) layer Information Element (IE), or a Physical Uplink Control Channel (PUCCH).

At block 604, the base station configures resource elements to transmit phase-tracking reference signals in accordance with the configuration included in the request. For example, the resource manager 232 in the base station 104 configures one or more resource elements 312 to transmit phase-tracking reference signals. The one or more resource elements 312 may be configured in the frequency domain, the time domain, or both.

At block 606, the base station transmits the configured resource elements. For example, the base station 104 transmits the configured resource elements using the 5G NR transceiver 224, the RF front end 220, and the antennas 218.

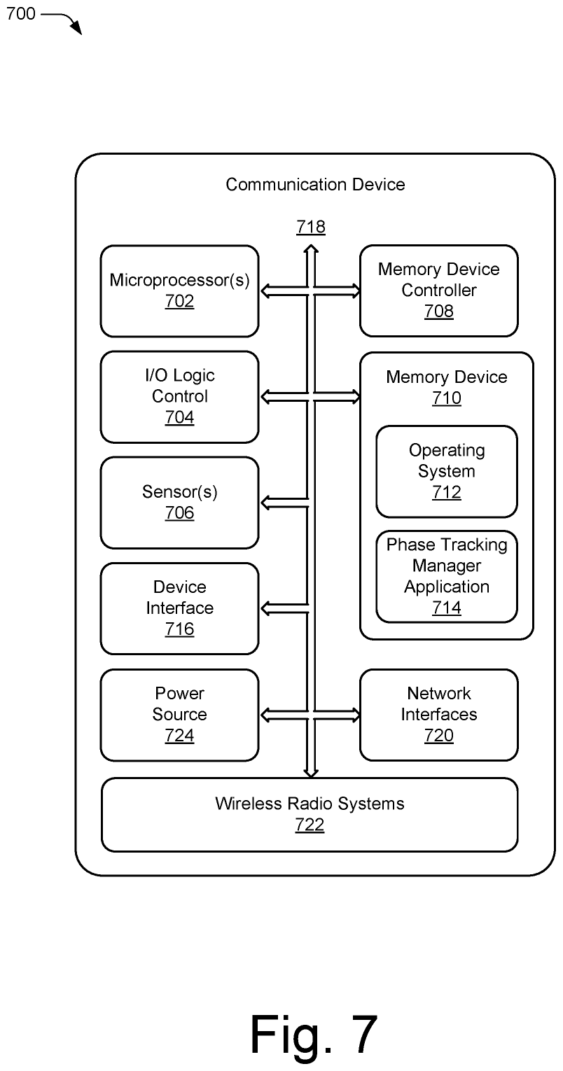

FIG. 7 illustrates an example communication device 700 that can be implemented as the user equipment 102 in accordance with one or more aspects of user equipment-initiated phase tracking for fifth generation new radio as described herein. The example communication device 700 may be any type of mobile communication device, computing device, client device, mobile phone, tablet, communication, entertainment, gaming, media playback, and/or other type of device.

The communication device 700 can be integrated with electronic circuitry, microprocessors, memory, input output (I/O) logic control, communication interfaces and components, as well as other hardware, firmware, and/or software to implement the device. Further, the communication device 700 can be implemented with various components, such as with any number and combination of different components as further described with reference to the user equipment 102 shown in FIGS. 1 and 2.

In this example, the communication device 700 includes one or more microprocessors 702 (e.g., microcontrollers or digital signal processors) that process executable instructions. The device also includes an input-output (I/O) logic control 704 (e.g., to include electronic circuitry). The microprocessors can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits.

The one or more sensors 706 can be implemented to detect various properties such as acceleration, temperature, humidity, supplied power, proximity, external motion, device motion, sound signals, ultrasound signals, light signals, global-positioning-satellite (GPS) signals, radio frequency (RF), other electromagnetic signals or fields, or the like. As such, the sensors 706 may include any one or a combination of temperature sensors, humidity sensors, accelerometers, microphones, optical sensors up to and including cameras (e.g., charged coupled-device or video cameras), active or passive radiation sensors, GPS receivers, and radio frequency identification detectors.

The communication device 700 includes a memory device controller 708 and a memory device 710 (e.g., the computer-readable storage media 212), such as any type of a nonvolatile memory and/or other suitable electronic data storage device. The communication device 700 can also include various firmware and/or software, such as an operating system 712 that is maintained as computer executable instructions by the memory and executed by a microprocessor. The device software may also include a phase tracking manager application 714 that implements aspects of user equipment-initiated phase tracking for fifth generation new radio. The computer-readable storage media described herein excludes propagating signals.

The communication device 700 also includes a device interface 716 to interface with another device or peripheral component and includes an integrated data bus 718 that couples the various components of the communication device 700 for data communication between the components. The data bus in the mesh network device may also be implemented as any one or a combination of different bus structures and/or bus architectures.

The device interface 716 may receive input from a user and/or provide information to the user (e.g., as a user interface), and a received input can be used to determine a setting. The device interface 716 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 716 may also receive inputs from any number of peripherals, such as buttons, a keypad, a switch, a microphone, and an imager (e.g., a camera device).

The communication device 700 can include network interfaces 720, such as a wired and/or wireless interface for communication with other devices via Wireless Local Area Networks (WLANs), wireless Personal Area Networks (PANs), and for network communication, such as via the Internet. The network interfaces 720 may include Wi-Fi, Bluetooth™, BLE, Near Field Communication (NFC), and/or IEEE 802.15.4. The communication device 700 also includes wireless radio systems 722 for wireless communication with cellular and/or mobile broadband networks. Each of the different radio systems can include a radio device, antenna, and chipset that is implemented for a particular wireless communications technology, such as the antennas 202, the RF front end 204, the LTE transceiver 206, and/or the 5G NR transceiver 208. The communication device 700 also includes a power source 724, such as a battery and/or to connect the device to line voltage. An AC power source may also be used to charge the battery of the device.

Although aspects of user equipment-initiated phase tracking for fifth generation new radio have been described in language specific to features and/or methods, the subject of the appended claims is not necessarily limited to the specific features or methods described. Rather, the specific features and methods are disclosed as example implementations of user equipment-initiated phase tracking for fifth generation new radio, and other equivalent features and methods are intended to be within the scope of the appended claims. Further, various different aspects are described, and it is to be appreciated that each described aspect can be implemented independently or in connection with one or more other described aspects.

1. A method of configuring one or more phase-tracking reference signals by a user equipment (UE) in a wireless communication network, the method comprising:
determining, by the UE, a current operating condition related to a wireless communication link;
based on the determining the current operating condition, selecting a configuration for one or more air interface resources selected to transmit a phase-tracking reference signal (PT-RS);
transmitting a request to a base station, the request including the selected configuration for the one or more air interface resources; and
receiving, via the wireless communication link and from the base station, at least some of the one or more air interface resources in the selected configuration, each of the at least some of the one or more air interface resources including the PT-RS.

2. The method of claim 1, comprising:
transmitting, by the UE, a request to the base station to turn off transmission of phase-tracking reference signals.

3. The method of claim 1, comprising:
transmitting, by the UE, a request to the base station to turn on transmission of phase-tracking reference signals.

4. The method of claim 3, wherein the transmitting the request to turn on the transmission of the phase-tracking reference signals is effective to cause the base station to transmit one or more air interface resources, each of the one or more air interface resources including the PT-RS.

5. The method of claim 1, wherein the current operating condition includes a phase noise characteristic of the UE, a noise floor of the UE, a temperature of the UE, a carrier frequency, a frequency band, or any combination thereof.

6. The method of claim 1, wherein the configuration for one or more air interface resources configures one or more resource elements in the frequency domain, the time domain, or both.

7. The method of claim 1, wherein the request to the base station is transmitted using a Radio Resource Control (RRC) connection, a Media Access Control (MAC) layer Information Element (IE), or a Physical Uplink Control Channel (PUCCH).

8. The method of claim 1, wherein the wireless communication link is a Fifth Generation New Radio (5G NR) wireless communication link, and wherein the base station is a Next Generation Node B (gNode B).

9. A user equipment (UE) comprising:
a radio frequency (RF) transceiver; and
a processor and memory system to implement a phase tracking manager application configured to:
determine a current operating condition related to a wireless communication link between the UE and a base station;
based on the determination of the current operating condition, select a configuration for one or more air interface resources selected to transmit a phase-tracking reference signal (PT-RS);
transmit a request to the base station, using the RF transceiver, the request including the selected configuration for the one or more air interface resources; and
receive, via the wireless communication link and using the RF transceiver, at least some of the one or more air interface resources in the selected configuration, each of the at least some of the one or more air interface resources including the PT-RS.

10. The user equipment of claim 9, wherein the current operating condition includes a phase noise characteristic of the UE, a noise floor of the UE, a temperature of the UE, a carrier frequency, a frequency band, or any combination thereof.

11. The user equipment of claim 9, wherein the configuration for one or more air interface resources configures one or more resource elements in the frequency domain, the time domain, or both.

12. The user equipment of claim 9, the phase tracking manager application is configured to:
in response to the reception of the one or more air interface resources, configure the RF transceiver to compensate for phase noise in received air interface resources.

13. The user equipment of claim 9, wherein the RF transceiver is a 5G NR transceiver.

14. The user equipment of claim 13, the UE comprising a second RF transceiver, wherein the second RF transceiver is a Long Term Evolution (LTE) transceiver, and wherein the request is transmitted to the base station using the LTE transceiver.

15. The user equipment of claim 9, wherein the request to the base station is transmitted using a Radio Resource Control (RRC) connection, a Media Access Control (MAC) layer Information Element (IE), or a Physical Uplink Control Channel (PUCCH).

16. A system comprising:
a gNode B (gNB); and
a user equipment (UE) configured to:
determine a current operating condition related to a wireless communication link between the UE and the gNB;
based on the determination of the current operating condition, select a configuration for one or more resource elements selected to transmit a phase-tracking reference signal (PT-RS);
transmit a request to the gNB, the request including the selected configuration for the one or more resource elements; and
receive, from the gNB and via the wireless communication link, at least some of the one or more resource elements in the selected configuration, each of the at least some of the one or more air interface resources element including the PT-RS.

17. The system of claim 16, the gNB configured to:
receive the request from the UE;
configure resource elements in accordance with the configuration included in the request; and
transmit the configured resource elements.

18. The system of claim 16,
the UE configured to:
transmit another request to the gNB, the other request including an indication to stop transmission of phase-tracking reference signals; and
the gNB configured to:
in response to receiving the other request, stop the transmission of the phase-tracking reference signals.

19. The system of claim 18, wherein the UE transmits the request to the gNB using a Radio Resource Control (RRC) connection, a Media Access Control (MAC) layer Information Element (IE), or a Physical Uplink Control Channel (PUCCH).

20. The system of claim 16, wherein the configuration of one or more resource elements configures the one or more resource elements in the frequency domain, the time domain, or both.
